(19) United States
(12) Patent Application Publication
(10) Pub. No.: US 2004/0100626 A1
(43) Pub. Date: May 27, 2004

(54) Method and device for operating a pmd system

(76) Inventors: Peter Gulden, Munchen (DE); Patric Heide, Vaterstetten (DE); Martin Vossiek, Hildesheim (DE)

Correspondence Address: YOUNG & THOMPSON, 745 SOUTH 23RD STREET 2ND FLOOR, ARLINGTON, VA, 22202

(21) Appl. No.: 10/343,998

(22) PCT Filed: Aug. 10, 2001
(86) PCT No.: PCT/DE01/03078

(30) Foreign Application Priority Data
Aug. 11, 2000 (DE) 10039422.1

(51) Int. Cl. G01P 3/36

(52) U.S. Cl. 356/28.5

(57) ABSTRACT

The invention relates to a method for controlling a PMD system which is characterized by controlling a photoelectronic mixing device (PMD) by at least one modulation signal (U_{mod}) and one modulation signal (U_{mod}) that is complementary thereto. A transmitter (E) emits electromagnetic radiation that is intensity-modulated by means of the at least one modulation signal (U_{mod}). The inventive method is further characterized by varying the modulation signal (U_{mod}) between at least two modulation frequencies (f₁,f₂,fᵢ).

The invention relates to methods and devices for operating a PMD system.

A PMD (“Photoelectronic Mixing Device”) corresponds in principle to a pixel of a CMOS camera chip. In addition to the intensity of the light, it is also possible to measure in the PMD a transit time τ between a transmitted intensity-modulated wave, typically light, and the wave P_{M} received by the PMD. For this purpose, the transmitter emits an intensity-modulated wave that strikes the PMD after traversing a transmission link. There, the wave generates charge carriers as on a conventional photodiode. The number of the charge carriers generated is proportional in this case to the intensity of the wave.

One property of a PMD system consists in that two opposite outputs A and B are opened alternatingly. The switchover between the two outputs is performed via a modulation signal U_{mod} that is applied to the PMD. This voltage is modulated with the same frequency f_{mod} as the transmitter. If the wave now reaches the PMD without delay, the time in which charge carriers are generated corresponds to the opening time of output A. The charges generated therefore reach output A in their entirety. If the wave strikes the PMD with a delay, the charge carriers are correspondingly generated later. Thus, a portion of the charges is generated during the opening time of output A, whereas a further portion is generated during the opening time of output B. The difference between output A and output B is therefore a measure of the transit time τ of the signal, the sum of A and B is a measure of the intensity of the incident light; on this point see DE 197 04 496 A1 or R. Schwarte et al.: “Schnelle und einfache optische Formerfassung mit einem neuartigen Korrelations-Photodetektor-Array” [“Quick and simple optical detection of shape with the aid of a novel correlation photodetector array”], Lecture at the DGZfP-GMA specialist conference in Langen, 28/29 April 1997.

The read-out voltages Uₐ, U_{b} can be generated directly by the generated large current (non-integrating mode).

In an integrating mode, the read-out voltages Uₐ and U_{b} are the voltages that arise after integration of the charges at the charge pots. Integrating PMDs have the peculiarity that the pots in which the charge carriers are collected must be emptied regularly by means of a reset signal R of length t_{R}. The resetting can be performed either after permanently prescribed time intervals tᵢₙₜ at the frequency fᵢₙₜ=1/tᵢₙₜ or adaptively when a certain voltage threshold is reached at the charge pots.

Depending on the design of the accumulation gates (integrating/non-integrating), and assuming equal frequencies of the incident sinusoidally intensity-modulated light wave and of the modulation signal, and given subsequent suppression of high-frequency components by means of a lowpass filter, the following holds for the output signals Uₐ, U_{b} of the PMD, which correspond the product of the incident electromagnetic waves and the modulation signal U_{PMD mod} or the complementary modulation signal \overline{U}_{mod} phase-shifted by 180°:

Uₐ=κ·P_{M}·cos(Δφ)+κ·P_{H}/2 (1)

U_{b}=κ·P_{M}·cos(Δφ+180°)+κ·P_{H}/2 (2)

The lowpass filter is preferably already implemented within the integrated readout circuit, and is therefore not necessary as an external system component. In equations (1) and (2), Δφ correspond to the phase shift between the incident electromagnetic wave and the modulation signal, P_{M} corresponds to the power of the incident wave, κ corresponds to a proportionality factor taking account of the sensitivity of the PMD, the amplitude of the modulation voltage, the reflection coefficient at the object and the link attenuation, and P_{H} corresponds to the power of the background illumination. κ also further includes the integration time tᵢ in the case of integration PMDs. The background illumination is suppressed by forming a differential signal U_{d} and it holds for the differential signal U_{d}=Uₐ−U_{b} that:

U_{d}=κ·P_{M}·cos(Δφ)=const·cos(Δφ) (3).

The phase shift in the signal is then composed of the component owing to the transit time and a fixed phase shift φ_{d} for example because of different transit times τ in the electronic system or else delay elements:

Δφ=2π·f_{mod}·τ+φ_{d} (4).

The dependence of the output signals Uₐ,U_{b} and U_{d} both on cos(Δφ) and on P_{M} turns out in this case to be problematical for the correct calculation of the phase shift. If the suppression of the background illumination is not mandatory, the transit time τ and thus the distance of an object, or the Doppler frequency f_{d} and thus the speed of the object can be determined directly from equation (1) or (2).

Determining the phase difference or transit-time difference by picking up a plurality of measured values by means of phase-modulation methods (PSK methods) or PN modulation is known from Heinol, Xu and Schulte: “Laufzeitbasierte 3D-Kamera-systeme—Smart Pixel Lösungen” [“Systems based on runtime—Smart pixel solutions”], DGZIP specialist conference on optical detection of shape, Stuttgart Sep. 5-6, 1999. Integrating PMDs are used as a rule for this purpose. The phase delay φ_{d} is tuned in this case. Subsequently, a search is made for the maximum of the correlation curve thus obtained, and the transit time is determined from 2π·f_{mod}·τ=2π−φ_{dmax}. The technical outlay on the application of this method is considerable and so, for example, in the phase delay φ_{d} is generated by means of direct digital frequency synthesis (“DDS”) and a digital phase register.

An alternative method (“I-Q method”) is described in DE 197 04 496 A1, in accordance with which two values, mutually phase-shifted by 90°, for U_{d} are picked up either sequentially or by means of special pixel structures/arrangements. The phase Δφ is then calculated from these:

$$Δ ϕ = arctan \frac{{U}_{d} ( {90}^{∘} )}{{U}_{d} ( {0}^{∘} )}$$

Alternatively, DE 197 04 496 A1 propose orthogonal pseudo-noise codes (PN) that offer the advantage of multi-target capability.

The known methods proceed from static targets, that is to say targets not moving as measurements are being picked up. If, by contrast, the target objects are moving as measurements are being picked up, the transit time τ is no longer constant during measurement. With τ(t)=2·d(t)/c=2/c·(v_{d}·t+d₀), it holds that:

$$Δ ϕ = 2 π \cdot {f}_{mod} \cdot τ ( t ) + {ϕ}_{d} = 2 π \cdot {f}_{mod} \frac{2}{c} ( {v}_{d} \cdot t + {d}_{0} ) + {ϕ}_{d} \qquad ( 5 )$$

In this case, d corresponds to the current distance, d₀ to the initial distance, which corresponds to the initial transit time τ₀, while c is the speed of light and v_{d} the speed of the object. The differential signal U_{d} is yielded as:

$${U}_{d} = κ \cdot {P}_{M} \cdot cos ( Δ ϕ ) = κ \cdot {P}_{M} \cdot cos ( 2 π \cdot {f}_{mod} \frac{2}{c} ( {v}_{d} \cdot t + {d}_{0} ) + {ϕ}_{d} ) \qquad ( 6 )$$

by substituting equation (5) in equation (3).

This signal has a time-dependent phase. In this case, the time-dependent portion of the phase contains the speed information, and the constant portion contains the distance information. The time-dependent portion can be determined by differentiating the phase, and therefore corresponds to the frequency of the signal:

$$f = \frac{1}{2 π} \cdot \frac{\partial }{\partial t} Δ ϕ ( t ) = \frac{2}{c} {v}_{d} \cdot {f}_{mod} = 2 {f}_{d}$$

the corresponding to the Doppler frequency f_{d}=v_{d}/λ=v_{d}·f_{mod}/c according to E. Pehl: “Mikrowellen in der Anwendung” [“Applied microwaves”], Hüthig Verlag Heidelberg 1993. The frequency and thus the speed are then determined by means of spectral analysis (for example FFT) of the signal according to equation (6). Subsequently, the phase being sought can be determined, for example, as phase of the maximum in the frequency spectrum, and it is possible to calculate the distance from it by means of equation (4). It is assumed here in principle that the Doppler frequency is substantially lower than the cutoff frequency of the lowpass filter.

For the case of integrating measurement, a measuring error is obtained by the co-integrating time-dependent portion given a short integration time tᵢₙₜ<<1/f_{d} by comparison with the fundamental period of the Doppler signal. A differential signal proportional to the transit time of φ is no longer received given a long integration period tᵢₙₜ>>1/f_{d}. Consequently, the distance of moving objects can be measured at best with an increased measuring error. Furthermore, the two first-named methods acquire and measure only one target.

It is common to the said methods that they are based on a modulation of the phase delay φ_{d} in equation (4).

It is the object of the present invention to provide a possibility for operating a PMD of simplified design and increased measuring accuracy, and for measuring speed and/or distance.

This object is achieved by means of methods in accordance with patent claims 1 and 3, and by an arrangement in accordance with patent claim 17.

In order to permit measurement of speed, use is made of a PMD in which drive is provided by a modulation signal U_{mod} with a modulation frequency f_{mod} that is arbitrary, but then permanently selected, and by means of a modulation signal complementary thereto, and a transmitter emits electromagnetic radiation that is intensity-modulated by means of the at least one modulation signal U_{mod}.

The method is defined by the fact that a plurality of measured values are picked up by sampling at least one of the output signals Uₐ,U_{b} from equations (1), (2) and/or, preferably, by sampling the differential signal U_{d}, generated in analog fashion, from equation (3). The differential signal U_{d} can also be determined in this case numerically from the output signals Uₐ,U_{b}.

At least one associated spectrum is formed from the measurement series thus determined, in particular of the differential signal U_{d}, by means of a spectral analysis, in particular a fast Fourier transformation.

A signal component with a significant, in particular maximum amplitude is then determined in the spectrum, and the associated frequency fₘₐₓ of the signal component with a significant amplitude is determined. These can be one or more frequencies appertaining to an object in the case of the occurrence of a plurality of objects to be measured. For the purpose of speed measurement, preference is given, in particular, to the frequency fₘₐₓ with maximum amplitude.

A respectively associated Doppler frequency f_{d} can then, for example, be determined from one or more frequencies with significant, in particular maximum, amplitude. The Doppler frequency f_{d} can be used, in turn, to determine a speed. Given a plurality of determined speed, it is possible, for example, to achieve increased accuracy by weighted averaging.

This method can preferably be executed by means of an arrangement in which no integrator is connected downstream of the PMD, so that the differential signal U_{d} can be sampled directly over time. However, it is also possible to use an integrating PMD and to connect downstream of the latter a (time) differentiator, although in this case there is a substantial worsening of the signal-to-noise ratio.

Furthermore, if necessary, it is also possible to determine the transit time τ for distance measurement directly from the phase of the maximum in the complex Fourier spectrum, for example.

It is preferred for the method also to be used to measure the distance of an object apart from measuring speed, particularly when the distance is determined by means of the phase Δφ of the significant amplitude.

A further method for achieving the object consists in that a PMD is driven by means of at least one modulation signal U_{mod}, and a transmitter emits electromagnetic radiation that is intensity-modulated by means of the at least one modulation signal U_{mod}, the modulation signal U_{mod} now being varied between at least two modulation frequencies. Apart from being performed with the aid of U_{mod}, the drive is also typically performed with the aid of a modulation signal \overline{U}_{mod} complementary thereto; however, it can also be possible to use only the modulation signal U_{mod} for driving, while the complementary modulation signal \overline{U}_{mod} is generated, for example, by circuitry in the PMD. Also conceivable is a design of a PMD in which the complementary modulation signal \overline{U}_{mod} can be omitted owing to the physical structure of the PMD.

A method of variation of the modulation frequency (for example 2-FSK, n-FSKs, FMCW, FSCW) yields the advantage of a simpler arrangement, because, by contrast with the prior art, the arrangement for phase delay is omitted. The reduced number of elements in the modulation circuit further permits more accurate measurement and, in particular, reduction of the temperature drifts. Given the use of suitable evaluation algorithms, it is also possible to measure speed and distance simultaneously. This is important, for example, in the case of mounting on moving systems such as automobiles or robot platforms. In addition, the systems acquire multitarget capability, depending on method.

In both methods, there is no limitation of using a specific transmitter, but this is typically prescribed in practice by the intended application. For example, it is possible to use at least one light source (laser, laser array, mercury-vapor lamp, LED or LED array, fluorescent tube, etc.) or a transmitter (microwave transmitter, etc.) radiating in another band.

However, in both methods the use of the modulation signal U_{mod} or the complementary modulation signal \overline{U}_{mod} is equivalent, for example the transmitter can be driven with the aid of the modulation signal U_{mod} or of the complementary modulation signal \overline{U}_{mod}. Also conceivable are arrangements with two modulation signals that are mutually phase-shifted but not complementary.

At least one of the output signals Uₐ,U_{b} from equations (1),(2) is picked up, and/or, preferably, a plurality of measured values are picked up by sampling the differential signal U_{d}, generated in analog fashion from (3) in the case of the use of a plurality of modulation frequencies f₁,f₂,fᵢ, as well. The differential signal U_{d} can also be determined in this case numerically from the output signals Uₐ,U_{b}. Other suitable combinations of the output signals can also be used as long as they permit a unique calculation of the speed and/or distance of an object.

A plurality of methods for operating a PMD system are described below. Off course, the: invention is not limited to these.

a) Mono-Frequency Method

A measurement series can be picked up by removing the integrator used to date according to the prior art, see B. R. Schwarte et al., for example, an either continuous sampling of the differential signal U_{d} or sampling the output signals Uₐ, U_{b} while observing the sampling theorem. U_{d}(t) can also be determined in this case by digital subtraction of Uₐ and U_{b}. The Doppler frequency f_{d} can be obtained by means of spectral analysis (for example FFT) of the sampled signal from the discrete values for equation (6) or the signals Uₐ, U_{b}.

It is possible here to omit the integrator without any problem, since the known spectral analysis methods determine the averaged frequencies from all the measuring points, and this corresponds to averaging over all the measuring points. Consequently, in the case of this method for stationary targets, the signal-to-noise ratio is comparable with a signal-to-noise ratio at the end of the integration process.

The spectrum, for example the Fourier spectrum, is formed for further evaluation. A search is made in this spectrum for a signal component with a significant, in particular maximum, amplitude, and the associated frequency fₘₐₓ is determined. The speed can be determined therefrom. This is preferably done by determining the Doppler frequency f_{d} with f_{d}=fₘₐₓ/2.

Furthermore, it is also possible to determine the distance via the phase φ_{ges} of the signal, either directly as a phase of the signal component with a significant, in particular maximum, amplitude in the complex spectrum, or else, for example by means of the least square fit, see in this connection G. Strang, “Linear Algebra and its applications”, 3^{rd} ed. 1988, Harcourt Brace Jovanovich College Publishers. The transit time τ=(φ_{ges}−φ_{d})/(2Π·f_{mod}) is obtained from the phase.

It is preferred to use a non-integrating PMD for the purpose of picking up the spectrum easily. However, it is also possible to use an integrating PMD with downstream differentiator, but only in conjunction with a substantially worsened signal-to-noise ratio. A general disadvantage is that the delay offset φ_{d} must be known exactly, and the half wavelength of the modulation frequency corresponds to the uniqueness range of the method.

b) 2-Frequency Method (2-FSK Method)

The disadvantages of the one-frequency method can be avoided by using the two-frequency method. In this case, an amplitude- or intensity-modulated modulation signal U_{mod} (and \overline{U}_{mod}) with a modulation frequency f, is passed to the PMD and the transmitter. In the PMD, the received signal reflected from the object is overlaid with the modulation signal U_{mod}, and a first output signal, preferably the differential voltage. U_{d1}, is formed, either in an analog fashion or a digital one. A second modulation frequency f₂ is now set, and a second output signal, typically a second differential voltage U_{d2}, is picked up in the same way.

For each of the two modulation frequencies f₁,f₂, it is now possible to determined speed and/or distance separately in each case for moving targets, and subsequently the lower modulation frequency f₂ is used to determine the uniqueness range, and the higher modulation frequency f₁ is used to increase the accuracy.

This can be done, for example, by determining the respective Doppler frequency f_{d1},f_{d2} for both measurement series. As previously, the phase is subsequently determined for each of the two maxima in the frequency spectrum. The distance can be reconstructed from the phase, the phase for the low frequency f₂ being used, in particular, to achieve a wide uniqueness range. By contrast, the phase of the higher modulation frequency f₁ is used, in particular, for determining the distance more accurately. Consequently, use is typically made of two widely separated modulation frequencies f₁, f₂ in order thus to achieve a wide uniqueness range in conjunction with high accuracy. The sequence of the modulation frequencies f₁, f₂ can be varied at will.

Particularly with high frequencies, an advantage is yielded from the fact that the uniqueness range is determined by the lower frequency f₂, as a result of which the accuracy advantage of a high frequency f₁ is associated with the advantage of a wide uniqueness range. If the difference is substantially smaller than the modulation frequency, the phase delays caused in both paths by the additional transit times then also correspond. These delays then need no longer be known. A further advantage by comparison with the prior art is the elimination of the component for phase shifting.

However, the 2-frequency method also offers advantages in static measuring situations, in particular in the case of the integrated readout method. f₂ is then preferably selected such that the desired measurement range d_{w} can be measured uniquely. The equation f₂=(Π/4)·(c/d_{w}) is yielded in the case of a uniqueness range of Π/2. Two values U_{d1},U_{d2} are thus obtained for equation (3).

A method for determining distance consists in that two further values are picked up for each of the two frequencies, and the distance is calculated for each frequency using the I-Q method or the PSK method. Subsequently, the distance value of the low frequency is used to determine the uniqueness range, and that for the high frequency is used to achieve a high accuracy.

A determination of speed can be carried out in such a way that, once again, a distance appertaining to the frequency fₘₐₓ of the signal component with a significant amplitude is firstly determined separately from the phase Δφ in the spectrum appertaining to this frequency fₘₐₓ. A further calculating method is the direct formation of the coefficient of U_{d1} and U_{d2} from which it follows, proceeding from the same signal amplitude and integration time, that:

$$\frac{{U}_{d1}}{{U}_{d2}} = \frac{cos ( 2 π {f}_{1} \cdot \dot{τ} )}{cos ( 2 π {f}_{2} \cdot τ )} \qquad ( 7 )$$

The function thus produced depends only on the transit time τ.

The simple design and the use of only two measured values are advantageous in this method. Disadvantages are the lack of multitarget capability, restriction of the measurement range to T/4 of the higher frequency, and the use of a lookup table.

It is particularly preferred to select f₁=2·f₂, since in this case equation (7) can be solved analytically for τ using k=U_{d1}/U_{d2}:

$$τ = \frac{1}{2 π {f}_{1}} \cdot arccos ( \frac{k}{4} \pm \sqrt{\frac{{k}^{2}}{16} + 1} )$$

This equation is then solved in the microprocessor instead of the lookup table, and the storage space required is released.

The use of a sinusoidally modulated signal offers the advantage of simple electrical implementation, but the relationship between the phase of the received signal and the differential signal U_{d} is not linear, see equation (3).

It is therefore favorable in specific cases to use modulation signals U_{mod} with rectangularly modulated intensity. The relationship between phase and differential signal is then linear, and it holds for the integrating and non-integrating PMDs within a period 2π that:

$${U}_{d} = κ \cdot {P}_{M} \cdot ( 1 - 2 \cdot \frac{Δ ϕ}{2 π} ) \qquad ( 8 )$$

This linear relationship can also be used to implement the measurement of distance by means of a rectangularly modulated two-frequency method (2-FSK) in which, for example, the transit time τ can once again be calculated analytically from two stored modulation frequencies f₁ and f₂ in accordance with:

$$τ = \frac{( {U}_{d1} - {U}_{d2} )}{4 \cdot ( {U}_{d1} \cdot {f}_{2} - {U}_{d2} \cdot {f}_{1} )} \qquad ( 9 )$$

or given known frequencies f₁ and f₂ with k=f₂/f₁ as:

$$τ = \frac{1}{4 \cdot {f}_{2}} \cdot \frac{( {U}_{d1} - {U}_{d2} )}{( {U}_{d1} - {U}_{d2} \cdot k )} . \qquad ( 10 )$$

This offers the advantage that the second fraction in equation (10) can be implemented directly in analog fashion, and so there is no need for a microprocessor.

c) n-Frequency Shift Keying Method (n-FSK)

A generalized method is yielded when the transit time is determined for a plurality of frequencies instead of using only two frequencies. The use of the n-frequency method (n-FSK method), which constitutes a generalization of the 2-FSK method, offers the advantage of increased accuracy.

For this purpose, by analogy with the 2-FSK method, N different measurement values are picked up for N different discrete frequencies and stored in the microprocessor. In general, it is possible to use all the evaluation methods used in the 2-FSK method. However, there is also the possibility of direct evaluation by means of the least square fit method.

The transit time τ can be obtained directly in each measured value i for which it holds that:

U_{di}=2·κ·P_{M}·cos(Δφᵢ), where Δφᵢ=2·π·fᵢ·τ (11)

In this case, the parameter κ containing the integration time tᵢₙₜ and the sensitivity is the same for all i frequencies and is known. The received modulated radiation, typically light, is likewise constant for quickly sequential measurements, but the magnitude is not determined, because of the unknown reflectivity and the unknown transit path. The phase Δφᵢ is different for all the frequencies and likewise unknown. In summary, equation (11) can also be written as

U_{di}=K·P_{M}·Cᵢ (12)

where K=2·κ·tᵢₙₜ and Cᵢ=cos(Δφᵢ). Consequently, N+1 unknowns are present in the case of taking up measured values over N different frequencies.

This system of equations can be solved with the aid of the customary methods for solving underdetermined systems of equations, for example the least square fit method. The prior art for this is to be found, for example, in G. Strang. A possibility for increasing the accuracy resides in the use of the so-called weighted least square. In this case, the values for higher frequencies are taken into account with more weight. The transit time τ=(2Π·fᵢ)⁻¹ arccos(Cᵢ) is obtained from the solutions for Cᵢ in equation (12). The accuracy of τ is preferably increased by subsequently averaging over all i values. In this case, the corresponding τ can be more strongly weighted on the basis of the better accuracy in conjunction with higher frequencies. The advantage of this method consists in that all the values are used for calculating the distance.

The n-FSK is also suggested in the case of the use of rectangular modulation signals. By analogy with the 2-FSK method, the frequencies fᵢ are set sequentially, and the respective differential value U_{di} is picked up in each case. An overdetermined system of equations is thus obtained assuming only one reflector:

$${U}_{di} = κ \cdot {t}_{int} \cdot {P}_{M} \cdot ( 1 - 2 \cdot \frac{{ω}_{i} \cdot τ}{2 π} ) \qquad ( 13 )$$

This can be solved using the customary methods for solving overdetermined systems of equations for τ, see G. Strang.

d) Frequency Characteristic Method

A further frequency-modulated method for determining transit time/distance consists in using a detunable frequency generator, for example a voltage control oscillator (=VCO) to generate the modulation signal U_{mod}. The frequency U_{mod} of the modulation signal is set to a specific value in this case by the microprocessor. The output signal VCO is fed directly to the transmitter and reaches the PMD via the driver as in the case of the FSK method. The differential signal U_{d} produced is subjected to A/D conversion and stored by the microprocessor. The microprocessor then sets a new frequency value, and the next value for U_{d} is picked up.

As already described, the differential signal is proportional to reflectivity, integration time tᵢ and phase factor cos(Δφ). The phase difference for the various modulation frequencies is given by equation (4). Assuming the same reflectivity and integration time for the various frequencies, the result is then a characteristic of the phase difference against the frequency. The maxima, minima and zeroes of the characteristic correspond in this case to specific values Δφ:

Maximum: Δφ=2π

Minimum: Δφ=π, and

Zeroes:

$$Δ ϕ = \frac{1}{2} π and Δ ϕ = \frac{3}{2} π$$

It is thereby possible to use equation (4) to determine the distance from the position of the maximum, the minimum or the zeroes of the characteristic U_{d} against the frequency. It therefore holds for the distance that:

At the maximum:

$$d = \frac{c}{2 \cdot {f}_{max}}$$

At the minimum:

$$d = \frac{c}{4 \cdot {f}_{min}} ,$$

and

Zeroes

$$d = \frac{c}{8 \cdot {f}_{Null1}} and d = \frac{3 \cdot c}{8 \cdot {f}_{Null2}}$$

The distance can thus be obtained through minima, maxima or search for zeroes on the characteristic U_{d} against fᵢ. In this case, the accuracy can preferably be increased by interpolation between the discrete frequency values.

e) Frequency Modulated Continuous Wave (FMCW) Method

The frequency-modulated evaluation methods set forth above do not have multi-target capability. This can be solved by applying an FMCW (“Frequency Modulated Continuous Wave”) method.

Because of their function as mixers, PMD components are also suitable for measuring speed by means of an FMCW method. In this case, the radial speed v_{d} of an object relative to the PMD sensor is detected. In many applications, it is desired to measure distance d and speed v_{d} simultaneously. The method for determining speed from the differential values of distance images picked up sequentially is frequently too slow and inaccurate in this case.

Thus, in addition to the distance value the speed value is also advantageously available in each PMD pixel. In addition to this there is the increase in accuracy in the case of the distance measurement of moving objects, since the speed-induced component is taken into account in equation (6).

Furthermore, the FMCW method has multitarget capability, something which, in addition to the capture of targets situated one behind, another, offers the advantage of less disturbance by more distant targets.

The FMCW method can likewise be implemented with the aid of integrating and non-integrating PMDs, the latter being preferred because of the better noise-to-signal ratio.

f) Frequency Stepped Continuous Wave (FSCW) Method

When use is made of integrating PMDs, it is possible to use the FSCW method instead of a continuous sweep. As previously already the case with the n-FSK method, either the values of the differential signal U_{d} or the output signals Uₐ,U_{b} are picked up sequentially for various frequency values. In this case, the frequency is successively increased by a constant amount Δf, preferably departing from a low starting frequency f₀, for example 1 MHz. Assuming only one signal transit path and a delay only by the transit time transmitter PMD (Δφ=Δφ_{tof}), it holds for the values thus picked up, after modifying equations (3) and (4), that:

U_{di}=κ·P_{M}·cos(Δφ_{tof})=κ·P_{M}·cos(2·π·(f₀+i·Δf)·τ) (15)

The derivation of the phase then corresponds to the mixed signal frequency ω, the so-called beat frequency. It then holds for N measured values and given the use of the overall bandwidth that

$$Δ {f}_{g} = N \cdot Δ f \text{:} ω = \frac{\partial }{\partial i} {Δϕ}_{tof} ( i ) = \frac{1}{2 π} \cdot \frac{Δ {ω}_{g}}{N} \cdot τ .$$

The transmit time or distance is then yielded as: τ=(N/Δfg)·f and dᵢ=(c·N)/(2·Δf_{g})·f. The spectrum of the measurement series is obtained if all the N values are arranged one behind another in a vector and the Fourier transform is calculated. It is possible from this to determine the transit time or distance from the position of the maximum in the Fourier spectrum. If, by contrast with the original assumption, a plurality of signal transit paths are present, a plurality of maxima then occur in the spectrum instead of one. The position of the corresponding maxima then specifies the transit time/distance of the respective signal path.

The FSCW method with Fourier evaluation advantageously permits operation of PMD components that has multitarget capability. As was already the case previously, the accuracy can be increased by interpolation between discrete frequency values.

Instead of making use of the FFT, it is also possible to determine the distance via the frequencies of the downmixed signal with the aid of other methods known methods for spectral analysis, for example AR, ARMA, or a Prony method. The prior art is given here, for example, in Steven M. Kay: “Modern Spectral Estimation”, 1988, PTR Prentice Hall, New Jersey.

A particularly simple application results for the FSCW method: it is possible here to expand and reformulate equation (12) for a plurality of target objects {Q} as:

$${U}_{d i} = {\sum }_{k = 1}^{Q} K \cdot {P}_{{M}_{k}} \cdot {C}_{i k} = {\sum }_{k = 1}^{Q} {a}_{k} \cdot {y}_{k} ( i )$$

This form of equation is denoted as a linear prediction equation and can be solved for the periodic signals assumed here with the aid of the customary methods for spectral analysis.

In order to use spectral analysis, for example FFT, to increase limited resolution or else to reduce the computation time, the FSCW method can be used in the expansion of the n-FSK method after Ybarra et al., “Optimal Signal Processing of Frequency—Stepped CW Radar Data”, IEEE Transactions on Microwave Theory and Techniques, Vol. 43, No. 1, January 1995. It is possible thereby in addition to resolve a plurality of targets situated one behind another. For this purpose, Q reflecting objects {Q} are assumed, the result being to obtain a system of equations for all N frequencies. Depending on the system selected, the advantage are either the better resolution or the lesser computational outlay. This algorithm, originally developed for microwave systems, can be implemented in this case directly for the PMD.

The frequency-modulated mode of an PMD is explained in more detail schematically in the following exemplary embodiments, in which:

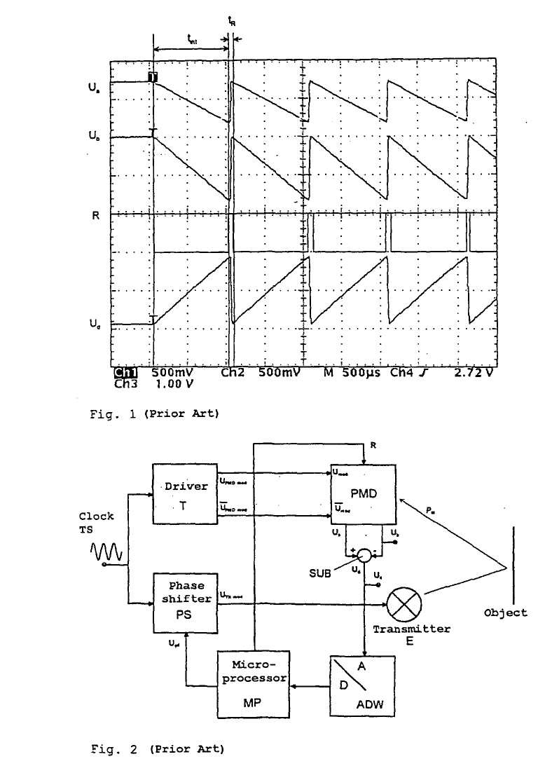

FIG. 1 shows a typical output and reset signal of an PMD element according to the prior art,

FIG. 2 shows an arrangement for determining the phase shift by means of a PSK method according to the prior art,

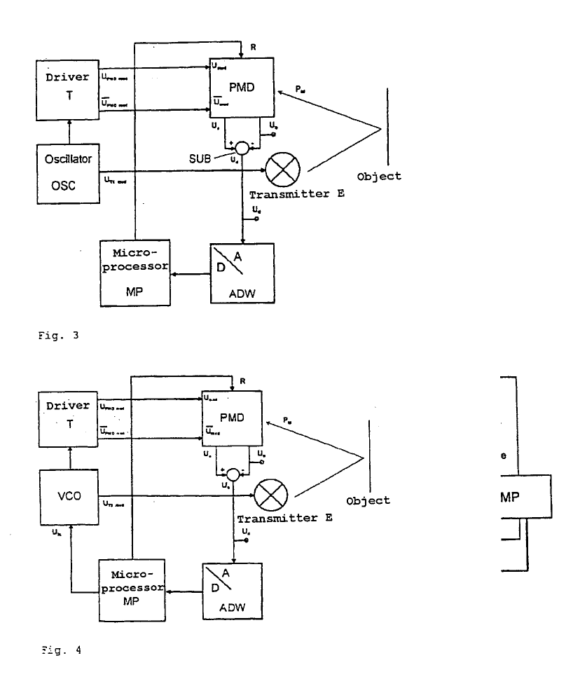

FIG. 3 shows an arrangement using a PMD in the mono-frequency frequency-modulated mode,

FIG. 4 shows an arrangement using a PMD in the 2-frequency method,

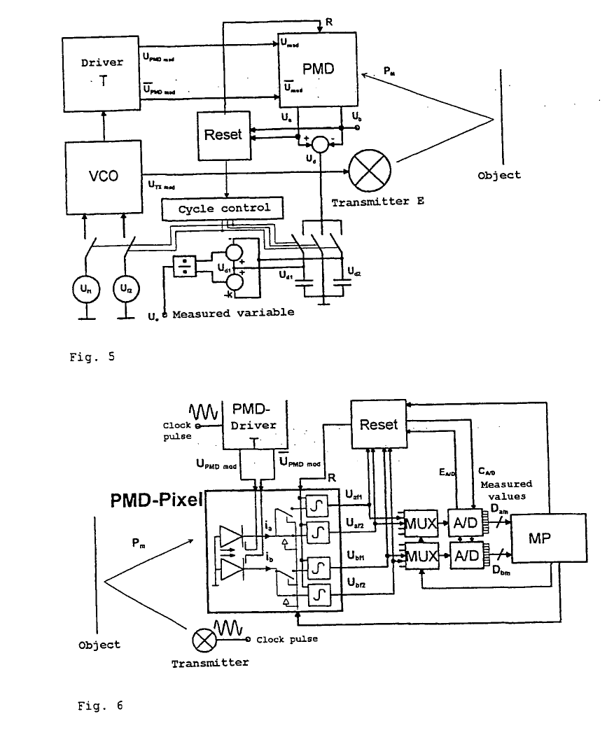

FIG. 5 shows a further arrangement using a PMD in the 2-frequency method,

FIG. 6 shows a system concept, corresponding to FIG. 5, with integration in a CMOS-PMD pixel,

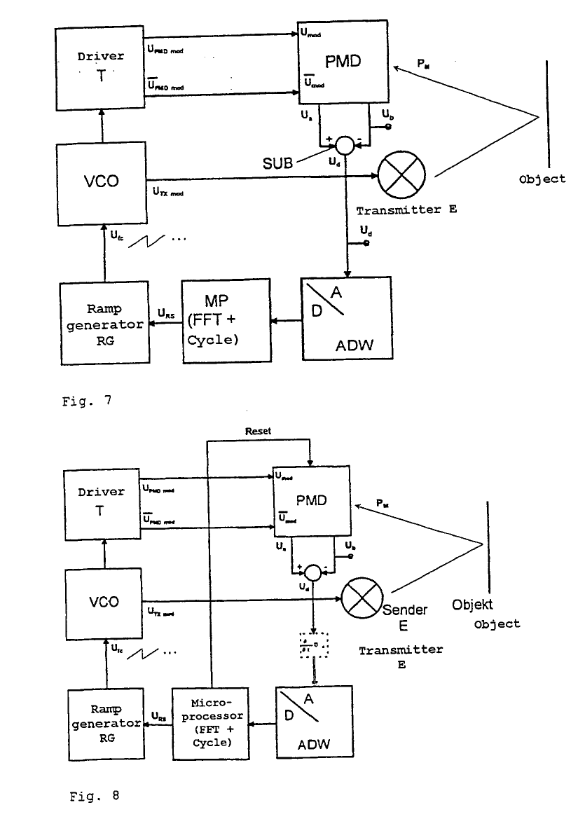

FIG. 7 shows an arrangement using a non-integrating PMD in the FMCW method,

FIG. 8 shows an arrangement using an integrating PMD in the FMCW method,

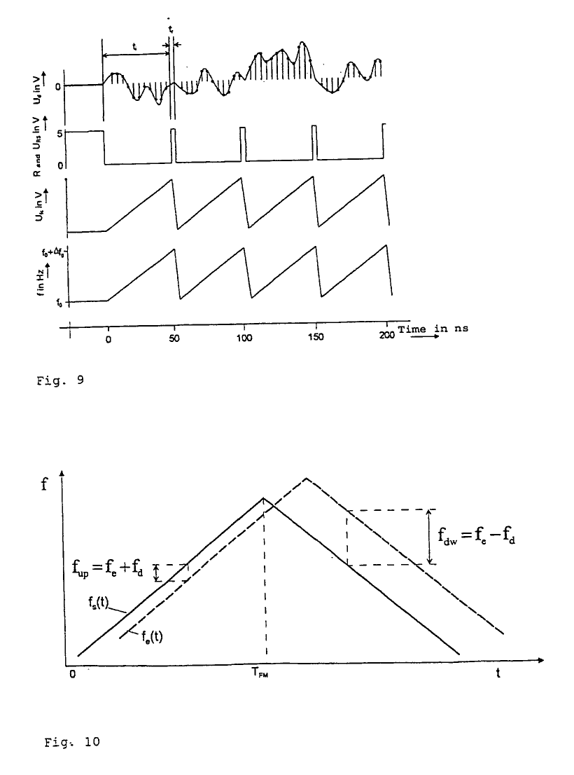

FIG. 9 shows a timing of the signals and of the sampling of the differential signal U_{d} in the case of the FMCW method,

FIG. 10 shows a linearly rising and falling ramp signal for driving in the case of the FMCW method.

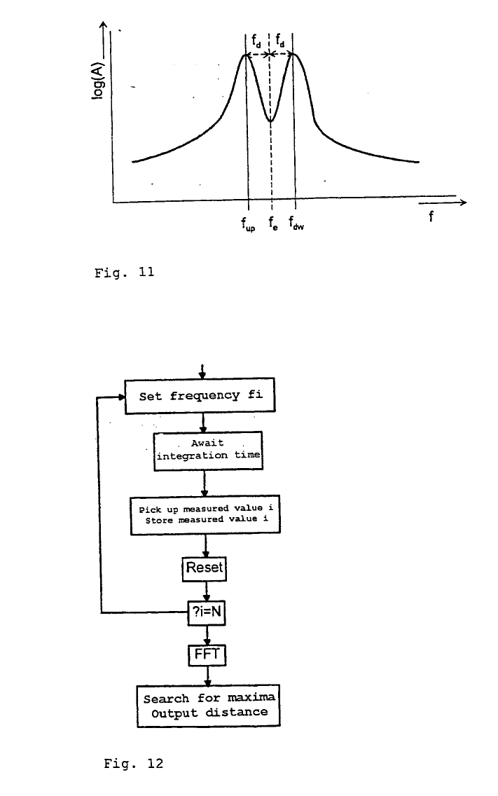

FIG. 11 shows a typical spectrum in the case of the FMCW method, and

FIG. 12 shows the cycle of an FMCW method.

As prior art, the output signals Uₐ and U_{b} of a PMD, the differential signal U_{d} and the reset signal R of the microprocessor MP in V are plotted in FIG. 1 against time t in μs for an integrating PMD element after Schwarte et al. The output signals Uₐ and U_{b} are in linear segments of the duration tᵢₙₜ and are reset by the reset signal R of the duration t_{R}. As prior art, FIG. 2 shows, as a circuit diagram according to Heinol et al., an arrangement for determining the phase shift by means of a PSK method.

In this case, a phase shifter PS and a driver T are clocked by means of a clock signal TS that is typically generated by a clock generator. The driver forwards the modulation signal U_{PMD mod} and the modulation signal \overline{U}_{PMD mod}, phase-shifted by 180°, to the PMD. The PMD generates the output signals Uₐ and U_{b} in accordance, inter alia, with the power P_{M} of the incident wave. The associated differential signal U_{d} can either be determined digitally or, preferably, by means of a, preferably analog, subtractor SUB. This subtractor SUB can also be integrated into the PMD pixel. The differential signal U_{d} is input via an A/D converter ADW into a microprocessor MP that, inter alia as a function of the value of U_{d}, both forwards the reset signal R to the PMD and forwards the phase signal U_{φd} to the phase shifter PS. The transmitter E, preferably a laser, is driven via the modulation signal U_{TX mod}, intended for it, by the phase shifter PS. U_{PMD mod} and U_{TX mod} differ from one another in their signal level only for the purpose of adaptation to the driven units.

The technical outlay for generating a phase delay that is appropriately accurate and simple to set is considerable in this case, and so the phase delay in Heinol et al. for example is generated by means of direct digital frequency synthesis (“DDS”) and a digital phase register.

FIG. 3 shows, as a circuit diagram, an arrangement using a PMD that is operated with one frequency.

An oscillator OSC sends a modulation signal U_{mod} with a constant modulation frequency f_{mod}. Its output signal U_{TX mod} is sent by the transmitter E in an intensity-modulated fashion and simultaneously reaches the PMD via the driver T, as U_{PMD mod}. There, it is overlaid in a fashion analogous to FIG. 2. The differential signal U_{d} is sampled directly by the A/D converter and stored in the microprocessor MP. A spectral analysis for determining the Doppler frequency is then performed there, as is the calculation of the phase. Again, in the possible case of an integrating PMD, downstream of which a differentiator should sensibly be connected, a reset signal R is sent from the microprocessor MP to the PMD.

FIG. 4 shows a possible circuit arrangement for operating a PMD arrangement in the 2-frequency method.

Firstly, a periodically, in particular sinusoidally, intensity-modulated signal, generated by a voltage-controlled oscillator VCO, with modulation frequency f₁ is sent from the transmitter E, typically a light source. In addition, this signal is passed to the PMD as modulation signal to a voltage-controlled oscillator VCO via the driver T. There, the received signal P_{M} is overlaid with the modulation signal U_{mod}, as already described. The differential voltage U_{d} is sampled in the time domain by means of the A/D converter ADW with sufficient speed, that is to say at least with twice the maximum expected Doppler frequency, and stored by the microprocessor MP.

A second frequency f₂ is now set, and the value U_{d2} resulting in this case is picked up. The Doppler frequency f_{d} is determined for both measurement series by means of spectral analysis. The distance is yielded in turn from the phase of the Doppler signal. In this case, the low frequency f₂ is used to achieve as wide as possible a uniqueness range, and the higher frequency f₁ serves to achieve a good accuracy. Alternatively, it is also possible to determine the two phases directly by means of a least square fit.

The device illustrated in this figure is also suitable for operation in a static measuring situation. It is preferred to use PMDs with an integrating readout method for the operation in static measuring situations.

For example, a sinusoidally intensity-modulated signal is firstly sent by the transmitter E of the with a first modulation frequency f₁ and additionally passed to the PMD as modulation signal U_{mod}. There, the received signal P_{M} is overlaid with the modulation signal U_{mod}, and the differential signal U_{d1}, which results for the differential voltage U_{d} after expiry of the integration time tᵢₙₜ, is stored by the microprocessor MP. A second, lower modulation frequency f₂ is now set, and the value U_{d2} yielded for this frequency is likewise stored.

The lower modulation frequency f₂ is preferably selected such that the desired measurement range d_{w} can be measured uniquely. The result is then f₂=(Π/4)·(c/d_{w}) for a uniqueness range of Π/2. Two values are thus obtained for equation (3).

It is then possible to determine the distance for the two modulation frequencies f₁,f₂ separately, and this permits a higher accuracy in conjunction with a wider uniqueness range during subsequent combination of the values.

Another evaluation is the division of the differential signals U_{d1}, U_{d2}. Equation (7) is obtained on the assumption of the same signal amplitude and integration time. The function thus produced depends only on the transit time τ, but it cannot be solved in an analytically closed fashion. Consequently, it is preferred to store a lookup table for the set frequencies in the microprocessor. The unique transit time range reaches in this case over a quarter period (T/4) of the higher frequency. When the method is applied, the coefficient of the measured values U_{d1}/U_{d2} is formed, for example, and then that transit time τ which corresponds to the coefficient is determined in the lookup table.

Particularly favorable is the selection of f₁=2·f₂, since equation (7) can be solved analytically for T in this case. Using k=U_{d1}/U_{d2}, it holds that:

$$\frac{{U}_{d1}}{{U}_{d2}} = \frac{cos ( 2 {ω}_{2} \cdot τ )}{cos ( {ω}_{2} \cdot τ )} ⇔ k \cdot cos ( {ω}_{2} \cdot τ ) - cos ( 2 {ω}_{2} \cdot τ ) = 0$$

Applying the addition theorems yields:

$$k \cdot cos ( {ω}_{2} \cdot τ ) = 2 \cdot {cos}^{2} ( {ω}_{2} \cdot τ ) - 1 ⇔ {cos}^{2} ( {ω}_{2} \cdot τ ) - \frac{k}{2} \cdot cos ( {ω}_{2} \cdot τ ) - 1 = 0.$$

This yields the analytical solution of the transition time τ:

$$τ = \frac{1}{2 π {f}_{1}} \cdot arccos ( \frac{k}{4} \pm \sqrt{\frac{{k}^{2}}{16} + 1} )$$

The equation is then solved in the microprocessor instead of the lookup table, and the required storage space is released.

The arrangement described in this figure is also suitable for using a square-wave modulated 2-FSK method. For this purpose, the voltage-controlled oscillator (VCO) is designed as a square-wave oscillator. Thus, during operation, a square-wave signal of specific modulation frequency f₁ is sent by the light source and passed as modulation signal to the PMD. The second frequency f₂ is preferably set in the same order of magnitude as f₁. The transit time is yielded from the two stored frequencies as:

$$τ = \frac{( {U}_{d1} - {U}_{d2} )}{4 \cdot ( {U}_{d1} \cdot {f}_{2} - {U}_{d2} \cdot {f}_{1} )} \qquad ( 9 )$$

Likewise suitable is the arrangement for carrying out an n-FSK method, for example with the aid of a sinusoidal or square-wave modulation signal.

Again, the arrangement from this figure is suitable for being operated by means of a frequency characteristic method.

FIG. 5 shows, as a circuit diagram, a further PMD system, particularly for the application of the 2-FSK method. The two frequencies f₁ and f₂ are known, and therefore k=f₂/f₁ is also known.

It is therefore possible, for example, to determine the transit time τ using equation (10). This arrangement offers the advantage that the second fraction in equation (10) is implemented directly in analog fashion. The arrangement then supplies an analog voltage signal directly proportional to the transit time τ, since the first fraction represents only a constant factor. The need for a microprocessor MP as in FIG. 4 is eliminated.

The analog evaluation circuit for equation (10) can also preferably be directly integrated in the PMD. The place of the voltage-controlled oscillator VCO can, in addition, be taken by a fixed-frequency generator LO whose output frequency is switched down with the aid of a divider. Appropriate dividers are prior art and are described, inter alia, in U. Tietze, T. Schenk, “Halbleiter-Schaltgungstechnik” [“Semiconductor circuit engineering”], chapter 10, pages 232 ff., tenth edition, Springer Verlag Berlin. However, integrated frequency dividers may be obtained.

The oscillator can also be replaced by a DDS module in FIGS. 4 and 5.

FIG. 6 shows, as a circuit arrangement, a system concept for integrating a PMD circuit in accordance with FIG. 5 in a CMOS-PMD pixel.

The first frequency f₁ is set at the beginning of the measurement. The charge carriers produced flow into the respective integrators. After a specific time interval, a switchover is made to the frequency f₂. The integrators are switched over at the same time such that the charge carriers now flow into a second integrator. The values of the respective two associated integrators then read out at the end of the second integration period, and the integrators reset by means of the reset signal R. If a reduction in the readout time is desirable, the first integrator can also already be read out during the second integration phase.

Integrating the circuit from FIG. 5 directly in the PMD pixel is particularly favorable. An analog voltage value proportional to the transit time τ is then available in each pixel. It is possible as a result, in particular, to eliminate postprocessing, which is expensive in the case of relatively large numbers of pixels, for example the digital subtraction of the two values. In addition, a distance signal is already available after one measurement. A particular advantage in this case is the use of the existing integration capacity as a sample and hold gate.

The arrangements according to FIGS. 4, 5 and 6 can advantageously be extended by an amplifier with switchable amplification in order wholly to utilize the dynamic range of the A/D converter in the case of small signals. FIG. 7 shows, as a circuit diagram, an arrangement for driving a PMD by means of an FMCW method, use being made of PMD elements with a non-integrating output.

A linearly rising ramp signal U_{fc} is generated either by the microprocessor MP or, preferably, by the ramp generator RG. The ramp signal U_{fc} is passed to the VCO and tunes the latter, starting from the fundamental frequency, over a bandwidth Δf_{g}. The frequency-modulated output signal of the VCO is sent by the transmitter E and passed as modulation signal to the PMD via the PMD driver T. There, it is overlaid with the received signal in a way described above. In conjunction with the corresponding time values t and the ramp duration T, it holds for the mixed signal U_{di} that:

$${U}_{d i} = K \cdot {P}_{M} \cdot cos ( Δ {ϕ}_{tof} ) = K \cdot {P}_{M} \cdot cos ( 2 \cdot π \cdot ( {f}_{0} + t \cdot \frac{Δ {f}_{g}}{T} ) \cdot τ ) \qquad ( 14 )$$

The result is the transit time/distance as frequency information in accordance with τ=(T/Δf_{g})·f and di=(c·T/(2Δf_{g}))·f. The frequency information can then be evaluated with the aid of the known methods for FMCW radar systems (FFT, ARMA or time domain methods). The prior art for spectral analysis is reproduced for the FFT in, for example, A. Oppenheim, W. Schäfer: “Discrete-Time Signal Processing”, 1989, Prentice Hall, Englewood Cliffs, for ARMA and Prony methods in, for example, S. Kay or S. L. Marple: “Digital Spectral Analysis with Applications”, 1988, Prentice Hall, Englewoods Cliffs, and for time domain methods in, for example, DE 19736693.

All spectral analysis methods form the mean frequencies from all the measuring points, and so it is possible, as preferred by the invention, to omit the integrator without losses in the case of the signal-to-noise ratio.

The mixed signal is digitized for this purpose in a directly sequential fashion by means of a fast A/D converter (ADW). It is necessary in this case for the sampling frequency to be selected using the sampling theorem such that it corresponds to twice the value of the maximum frequency of the mixed signal: fᵢ=2·(T/Δfg)·τₘₐₓ. Here, τₘₐₓ is the longest transit time to be measured, that is to say the measurement range fixes the required sampling frequency. Given a ramp duration of 10 ms and a bandwidth of 100 MHz, a cutout frequency of approximately 1.3 kHz results for distances of 0-10 m for a typical distance measuring unit.

The FMCW method for PMD pixels can advantageously be extended to the effect that, instead of a simple rising ramp, use is made of a firstly linearly rising and then linearly falling ramp as control signal. In addition to distance measurement, during an evaluation, this permits simultaneous measurement of the speeds via, the Doppler effect. In this case, the transmitted frequency is shifted in equation (6) by the so-called Doppler frequency f_{d}, see E. Pehl, for example.

The measuring principle is as follows in this case: during the rising ramp, the frequency of the downmixed signal corresponds to the sum of the frequency component fₑ caused by the transit time and the frequency component f_{d} caused by the radial speed. By contrast, during the falling ramp, the frequency of the downmixed signal is formed by the difference between the frequency component fₑ caused by the transit time and the frequency component f_{d} caused by the radial speed.

FIG. 8 shows a circuit diagram of an arrangement for the FMCW operation of integrating PMDs.

The cycle of the PMD control appears as follows in this case: the microprocessor/microcontroller MP initializes the ramp generator RG. The latter turns on a ramp that is forwarded as signal U_{fc} to the Vco, it being preferred for the entire bandwidth between two reset signal R to be tuned. For the typical signals, as shown in FIG. 1, of a PMDs currently available, the result is a ramp slope of 100 GHz/s given an integration time of approximately 1 ms and a bandwidth of approximately 100 MHz. If desired, the output signal of the PMDs is, differentiated continuously during the integration. In each case, the output signal is sampled sequentially between the two reset signals R and digitized. The reset signal R is triggered after the integration time or when the ramp end is reached.

In the two arrangements according to FIG. 7 and FIG. 8, the combination of VCO and ramp generator can also be replaced by a DDS module DDS or a PLL (Phase Locked Loop) synthesizer PLL that directly generates a linearly rising frequency signal.

Advantageous in the case of the two FMCW methods is the substantially shorter time, after which the first distance result is already present, and the multitarget capability.

A further advantage resides in the simultaneous measurement of speed and distance. By comparison with the prior art, this also leads to a more accurate measurement of the distance of moving targets, since the movement of the measurement targets produces the semantic measuring errors in the case of the methods of the prior art. The computational outlay for the spectral analysis is disadvantageous.

FIG. 9 shows a typical timing of the signals and the sampling of the differential signal in the case of the FMCW method with an integrating PMD, for example in accordance with FIG. 8.

The uppermost row shows a typical differential signal U_{d} in V, the second row of the reset signal R and U_{RS} in V, the third row of the ramp signal U_{fc} in V, and the lowermost row of the frequency f of the ramp signal in Hz, plotted in each case against the same time axis.

FIG. 10 shows the frequency f plotted against the time t for a firstly linearly rising and then linearly falling ramp signal for providing drive in the case of the FMCW method.

If, as previously, the mixed signal is now sampled with the aid of the A/D converter AD and an FFT is carried out, the spectrum has maxima at the points fᵤₚ=fₑ+f_{d} and f_{dw}=fₑ−f_{d}. The maxima are determined, in turn with the aid of suitable routines, the result then being the distance or speed, respectively, from fₑ=½(fᵤₚ+f_{dw}) and f_{d}=½(fᵤₚ−f_{dw}). It is thereby possible to determine speed and distance simultaneously by picking up only one spectrum.

FIG. 11 shows, as a logarithmic plot of an amplitude value A against the frequency, a typical spectrum that is determined in the case of an FMCW method with the aid of a drive characteristic in accordance with FIG. 10.

FIG. 12 shows a flowchart of the cycle of an algorithm for applying the FSCW method in the case of an integrated PMD.

It is preferred to set a starting frequency fᵢ, for example 1 MHz, starting from a lowest value. After awaiting the integration time, the associated measurement value i is picked up and stored. Resetting follows. Then the frequency fᵢ is advantageously increased successively by a constant amount Δf, and the measurements are picked up for this frequency.

A spectrum analysis, for example an FFT, by means of which the spectral components of the measurement series is obtained is carried out after all the values have been picked up. The transit time or distance can then be determined from the frequency of the spectral components.

1. A method for speed measurement by means of a PMD system, in the case of which
a PMD (PMD) is driven by means of at least one modulation signal (U_{mod}) with one modulation frequency (f_{mod}) and of a modulation signal (\overline{U}_{mod}) complementary thereto, and
a transmitter (E) emits electromagnetic radiation that is intensity-modulated by means of the at least one modulation signal (U_{mod}),
characterized in that
at least one output signal (Uₐ,U_{b}) of the PMD (PMD) or at least one signal (U_{d}) derived therefrom, in particular a differential signal (U_{d}), is picked up
a spectrum is formed by means a spectral analysis, in particular a fast Fourier transformation (FFT), from the at least one output signal (Uₐ,U_{b}) and/or the at least one signal (U_{d}) derived therefrom,
a signal component with a significant, in particular maximum, amplitude is determined in the spectrum,
the associated frequency (fₘₐₓ) is determined, and
a speed is calculated from this frequency (fₘₐₓ) of the signal component with a significant amplitude.

2. The method as claimed in claim 1, in which a distance appertaining to the frequency (fₘₐₓ) of the signal component with a significant amplitude is additionally determined from the phase (φ_{ges}) in the spectrum appertaining to this frequency (fₘₐₓ).

3. A method for operating a PMD system, in the case of which
a PMD (PMD) is driven by means of at least one modulation signal (U_{mod}), and
a transmitter (E) emits electromagnetic radiation that is intensity-modulated by means of the at least one modulation signal (U_{mod}),
characterized in that the modulation signal (U_{mod}) is varied between at least two modulation frequencies (f₁,f₂,fᵢ).

4. The method as claimed in claim 3, in which the modulation signal (U_{mod}) is switched over between two modulation frequencies (f₁,f₂).

5. The method as claimed in claim 4, in which speed and/or distance are/is determined separately for each of the two modulation frequencies (f₁,f₂), and subsequently the lower modulation frequency (f₂) is used to determine the uniqueness range, and the higher modulation frequency (f₁) is used to increase the accuracy.

6. The method as claimed in claim 5 for determining the speed for in each case one of the modulation frequencies (f₁,f₂), in the case of which
at least one output signal (Uₐ,U_{b}) of the PMD (PMD) or at least one signal (U_{d}) derived therefrom, in particular a differential signal (U_{d}), is picked up
a spectrum is formed by means a spectral analysis, in particular a fast Fourier transformation (FFT), from the at least one output signal (Uₐ,U_{b}) and/or the at least one signal (U_{d}) derived therefrom,
a signal component with a significant, in particular maximum, amplitude is determined in the spectrum,
the associated frequency (fₘₐₓ) is determined, and a speed for the respectively set modulation frequency (f₁,f₂) is calculated from this frequency (fₘₐₓ) of the signal component with a significant amplitude.

7. The method as claimed in claim 5 or 6 for determining the distance for in each case one of the modulation frequencies (f₁,f₂), in the case of which a distance appertaining to the frequency (fₘₐₓ) of the signal component with a significant amplitude is determined from the phase (φ_{ges}) in the spectrum appertaining to this frequency (fₘₐₓ).

8. The method as claimed in claim 4, in which distance is measured separately for each of the two modulation frequencies (f₁,f₂) with the aid of an I-Q method or a PSK method, and subsequently the lower modulation frequency (f₂) is used to determine the uniqueness range, and the higher modulation frequency (f₁) is used to increase the accuracy.

9. The method as claimed in claim 4, in which distance is determined by means of a coefficient U_{d1}/U_{d2}, in particular by using a lookup table or an analytical determination of the transit time (τ).

10. The method as claimed in one of claims 4 to 9, in which the modulation signal (U_{mod}) is switched over between more than two modulation frequencies (f₁,f₂,fᵢ).

11. The method as claimed in claim 10, in which a transit time (τ) is determined by means of a least square fit method.

12. The method as claimed in one of claims 4 to 11, in which the modulation signal (U_{mod}) is amplitude-modulated periodically, in particularly sinusoidally.

13. The method as claimed in one of claims 4 to 12, in which the lower modulation frequency (f₂) is selected in accordance with the measurement range du using the equation
f₂=(Π/4)·(c/d_{w})
c corresponding to the wave velocity.

14. The method as claimed in claim 13, in which the higher modulation frequency (f1) and the lower modulation frequency (f2) are related to one another by f₁=2·f₂.

15. The method as claimed in one of claims 4 to 14, in which the modulation signal (U_{mod}) is amplitude-modulated rectangularly.

16. The method as claimed in claim 3., in which
the modulation frequency (f₁,f₂,fᵢ) is varied by using a frequency characteristic method, and
a distance is performed by means of determining at least one characteristic point, in particular zeroes or extremes.

17. The method as claimed in claim 3, in which
the modulation frequency (f₁,f₂,fᵢ) is varied continuously by using an FMCW method,
a spectral analysis of at least one output signal (Uₐ,U_{b}) of the PMD (PMD) and/or of at least one signal (U_{d}) derived therefrom, in particular a differential signal (U_{d}), is carried out,
subsequently a search is made for one or more maxima in the spectrum resulting from the spectral analysis, and a speed or/and a distance is/are calculated from the associated frequency of at least one maximum.

18. The method as claimed in claim 3, in which
the modulation frequency (f₁,f₂,fᵢ) is varied in discrete steps of known spacing by using an FSCW method,
a spectral analysis of at least one output signal (Uₐ,U_{b}) of the PMD (PMD) and/or at least one signal (U_{d}) derived therefrom, in particular a differential signal (U_{d}), is carried out,
subsequently a search is made for one or more maxima in the spectrum resulting from the spectral analysis, and
a speed or/and a distance is/are calculated from the associated frequency of at least one maximum.

19. An arrangement for operating a PMD system, having
at least one PMD (PMD),
at least one transmitter (E), and
at least one signal generator (OSC,LO,DDS,VCO,PLL), by means of which a modulation signal (U_{mod}) can be sent to the PMD (PMD) and to the transmitter (E),
characterized in that the modulation signal (U_{mod}) can optionally be switched between at least two frequencies (f₁,f₂,fᵢ) by means of the signal generator (OSC,LO,DDS,VCO,PLL).

20. The arrangement as claimed in claim 19, in which the transmitter (E) has at least one laser, one LED, one mercury-vapor lamp, one fluorescent tube or one microwave transmitter.

21. The arrangement as claimed in one of claims 19 or 20, in which the signal generator has an oscillator (OSC), in particular a voltage-controlled oscillator (VCO) or a fixed-frequency oscillator (LO), or a PLL synthesizer (PLL) or a DDS module.

22. The arrangement as claimed in one of claims 19 to 21, in which the PMD (PMD) is connected to a microprocessor (MP) via an A/D converter (ADW).

23. The arrangement as claimed in one of claims 19 to 22, in which, in the PMD (PMD), at least two sample-and-hold gates are integrated in which there is stored at least one output signal (Uₐ,U_{b}) of the PMD (PMD) or at least one signal (U_{d}), in particular a differential signal (U_{d}), derived therefrom, that can be switched over alternatingly as a function of the set modulation frequencies (f₁,f₂,fᵢ).

24. The arrangement as claimed in claim 23, in which, for each read-out output, use is made of two sample-and-hold gates that can be switched over simultaneously with the switchover between the modulation frequencies (f₁,f₂,fᵢ).

25. The arrangement as claimed in claim 24, in which there is connected downstream of at least one sample-and-hold gate an analog evaluation circuit that is either external or integrated directly into a chip containing the PMD (PMD).

26. The arrangement as claimed in one of the preceding claims, in which the PMD (PMD) is of non-integrating design.
